(19) United States
(12) Patent Application Publication
(10) Pub. No.: US 2011/0280160 A1
(43) Pub. Date: Nov. 17, 2011

(54) VoIP Caller Reputation System

(75) Inventor: Weilai Yang, Alpharetta, GA (US)

(73) Assignee: McAfee, Inc., Santa Clara, CA (US)

(21) Appl. No.: 13/108,465

(22) Filed: May 16, 2011

Related U.S. Application Data
(60) Provisional application No. 61/334,790, filed on May 14, 2010.

(51) Int. Cl. H04L 12/16

(52) U.S. Cl. 370/259

(57) ABSTRACT

Methods and systems for collecting data from a plurality of voice over Internet protocol (VoIP) calls and determining at least one attribute for each of the plurality of calls. Relationships between the VoIP calls based on the determined attributes are identified, and a reputation score is assigned to a first entity based on the identified relationships. A call policy is associated with a caller reputation profile based on the reputation score.

### CROSS-REFERENCE TO RELATED APPLICATIONS

This application claims priority under 35 U.S.C. §119(e) to U.S. Provisional Application Ser. No. 61/334,790 titled “VoIP Caller Reputation System” filed May 14, 2010, the disclosure of which is incorporated herein by reference in its entirety.

### TECHNICAL FIELD

This document relates generally to systems and methods for processing VoIP communications and more particularly to systems and methods for creating and utilizing a VoIP caller reputation score to characterize an incoming VoIP call.

### BACKGROUND

In the telecommunications industry Voice over Internet Protocol (VoIP) has emerged as a common method for placing phone calls. VoIP allows voice calls to be routed through the Internet in packets, a process that is similar to the manner in which email and other data travels through the Internet. A VoIP call can originate from a VoIP telephone system with a direct connection to the Internet, or can originate from a PSTN phone and be converted into a VoIP call within the telecommunications network or vice versa.

### SUMMARY

Systems and methods for creating and utilizing a VoIP caller reputation score to characterize an incoming call are provided. Systems used for creating and utilizing a caller reputation score can include a data collection module, an attribute identification module, a reputation assignment module, and a policy enforcement module. The data collection module can receive a plurality of VoIP calls and collect data regarding the calls. The attribute identification module can extract attributes from the call data collected. The reputation assignment module can identify relationships between the VoIP calls received and assign a reputation score to callers based on the relationship of the calls. The Policy enforcement module can apply a policy to an unknown call based upon its relationship to a caller reputation score.

Methods of creating and utilizing a VoIP reputation score to characterize an incoming call can include: collecting data from a plurality of VoIP calls; determining at least one attribute for each of the plurality of calls from the data collected for each call; identifying relationships between the VoIP calls based on the determined attributes; assigning a reputation score to a first entity based on the identified relationships; and associating a call policy with a caller reputation profile based on the reputation score.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram depicting an example network in which voice over Internet protocol reputation systems and methods can operate.

FIG. 2 is a block diagram depicting an example network architecture of a voice over Internet protocol reputation system.

FIG. 3 is a block diagram depicting an example of communications and entities including identifiers and attributes used to detect relationships between entities.

FIG. 4 is a block diagram illustrating an example voice over Internet protocol reputation system.

FIG. 5 is a block diagram illustrating an example call filtering system using a voice over Internet protocol reputation system.

FIG. 6 is a block diagram illustrating an example network architecture including local reputations derived by local reputation engines and a global reputation stored by one or more servers.

FIG. 7 is a block diagram illustrating an example resolution between a global reputation and a local reputation.

FIG. 8 is a block diagram illustrating example reputation based connection throttling for voice over Internet protocol (VoIP) or short message service (SMS) communications.

FIG. 9 is a flowchart illustrating an example method of detecting relationships and assigning reputations to entities associated with VoIP calls.

FIG. 10 is a flowchart illustrating an example method of filtering incoming VoIP calls.

### DETAILED DESCRIPTION

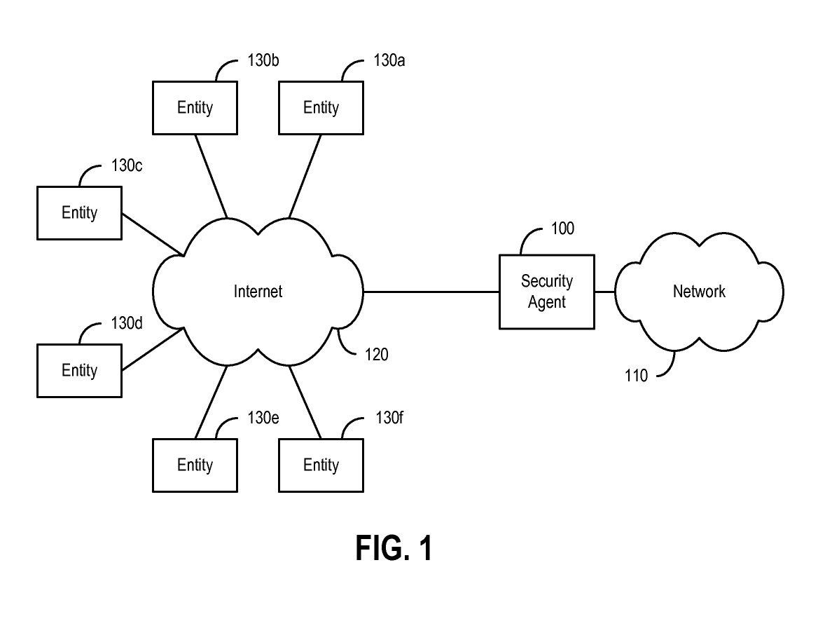

FIG. 1 is a block diagram depicting an example network in which voice over Internet protocol reputation systems and methods can operate. Security agent 100 can reside between a firewall system and servers internal to a network 110 (e.g., an enterprise network). In some implementations, the network 110 can include a number of servers, including, for example, electronic mail servers, web servers, and various application servers as may be used by the enterprise associated with the network 110.

The security agent 100 can monitor communications entering and exiting the network 110. These communications can be received through the Internet 120 from any entity 130a-f that is connected to the Internet 120. One or more of the entities 130a-f can be legitimate originators of communications traffic. However, one or more of the entities 130a-f can instead be non-reputable entities originating unwanted communications. As such, the security agent 100 includes a reputation engine. The reputation engine can inspect a communication and to determine a reputation associated with an entity that originated the communication. The security agent 100 can process the communication based upon the reputation of the originating entity. If the reputation indicates that the originator of the communication is reputable, for example, the security agent can forward the communication to the recipient of the communication. However, if the reputation indicates that the originator of the communication is non-reputable, for example, the security agent can quarantine the communication, perform additional tests on the message, or require authentication from the message originator, among many others.

There are a variety of techniques that can be used to implement a reputation engine. Example reputation engines are described in detail in United States Patent Publication No. 2006/0015942, which is hereby incorporated by reference.

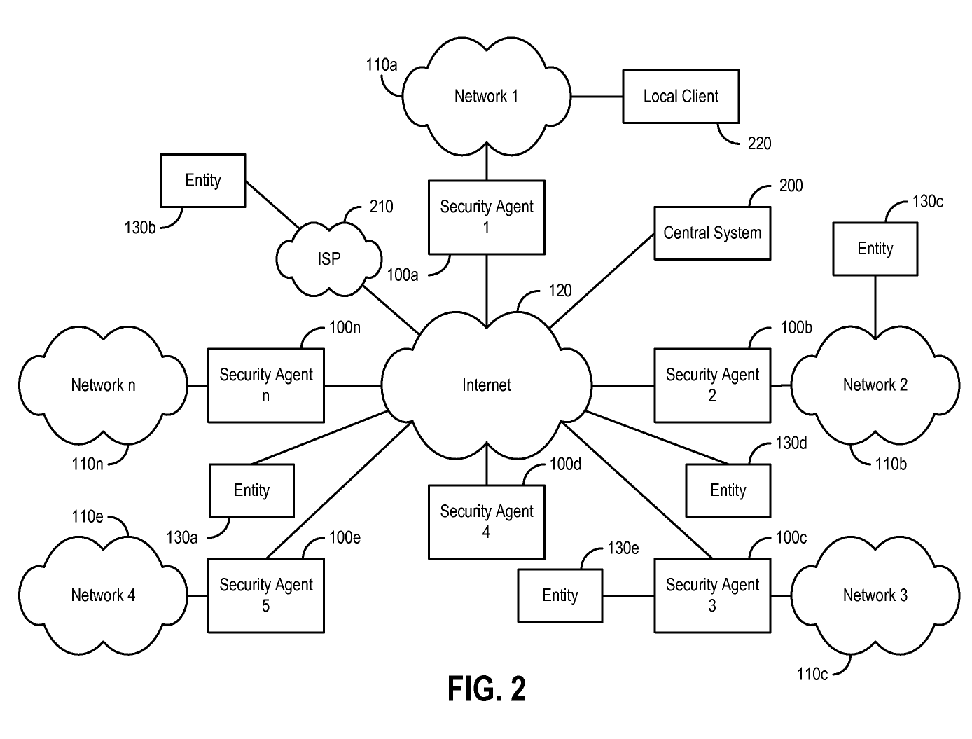

FIG. 2 is a block diagram depicting an example network architecture of a voice over Internet protocol reputation system. Security agents 100a-n are shown, in this example, logically residing between networks 110a-n, respectively, and the Internet 120. While not shown in FIG. 2, a firewall may be installed between the security agents 100a-n and the Internet 120 to provide protection from unauthorized communications from entering the respective networks 110a-n. Moreover, intrusion detection systems (IDS) can be deployed in conjunction with firewall systems to identify suspicious patterns of activity and to signal alerts when such activity is identified.

While such systems provide some protection for a network, they typically do not address application level security threats. For example, hackers often attempt to use various network-type applications (e.g., e-mail, web, instant messaging (IM), phone, etc.) to create a pre-textual connection with the networks 110a-n in order to exploit security holes created by these various applications using entities 130a-e or to collect information about services offered by the network. However, not all entities 130a-e are threats to the network 110a-n. Some entities 130a-e originate legitimate traffic, allowing the employees of a company to communicate with business associates more efficiently. While examining the communications for potential threats is useful, it can be difficult to maintain current threat information because attacks are being continually modified to account for the latest filtering techniques. Thus, security agents 100a-n can run multiple tests on a communication to determine whether the communication is legitimate.

Furthermore, sender information included in the communication can be used to help determine whether a communication is legitimate. As such, security agents 100a-n can track entities and analyze the characteristics of the entities to help determine whether to allow a communication to enter a network 110a-n. The entities 130a-n can then be assigned a reputation. Decisions on a communication can take into account the reputation of an entity 130a-e that originated the communication. Moreover, one or more central systems 200 can collect information on entities 130a-e and distribute the collected data to other central systems 200 and/or the security agents 100a-n.

Reputation engines can assist in identifying the bulk of the malicious communications without extensive and potentially costly local analysis of the content of the communication. Reputation engines can also help to identify legitimate communications and prioritize their delivery and reduce the risk of misclassifying a legitimate communication. Moreover, reputation engines can provide a dynamic and predictive approaches to the problem of identifying malicious, as well as legitimate, transactions in physical or virtual worlds. Examples include the process of filtering malicious communications in an email, instant messaging, VoIP, SMS or other communication protocol system using analysis of the reputation of sender and content. A security agent 100a-n can then apply a global or local policy to determine what action to perform with respect to the communication (such as deny, quarantine, load balance, deliver with assigned priority, analyze locally with additional scrutiny) to the reputation result.

The entities 130a-e can connect to the Internet in a variety of methods; and an entity 130a-e can have multiple identifiers (such as, for example, e-mail addresses, IP addresses, identifier documentation, phone numbers, etc) at the same time or over a period of time. For example, a mail server with changing IP addresses can have multiple identities over time. Moreover, one identifier can be associated with multiple entities, such as, for example, when an IP address is shared by an organization with many users behind it. Moreover, the specific method used to connect to the Internet can obscure the identification of the entity 130a-e. For example, an entity 130b may connect to the Internet using an Internet service provider (ISP). Many ISPs use dynamic host configuration protocol (DHCP) to assign IP addresses dynamically to entities 130b requesting a connection. Entities 130a-e can also disguise their identity by spoofing a legitimate entity. Thus, collecting data on the characteristics of each entity 130a-e can help to categorize an entity 130a-e and determine how to handle a communication.

The ease of creation and spoofing of identities in both virtual and physical world can create an incentive for users to act maliciously without bearing the consequences of that act. For example, a stolen IP address on the Internet of a legitimate entity by a criminal can enable that criminal to participate in malicious activity with relative ease by assuming the stolen identity. However, by assigning a reputation to the physical and virtual entities and recognizing the multiple identities that they can employ, reputation systems can influence reputable and non-reputable entities to operate responsibly for fear of becoming non-reputable, and being unable to correspond or interact with other network entities.

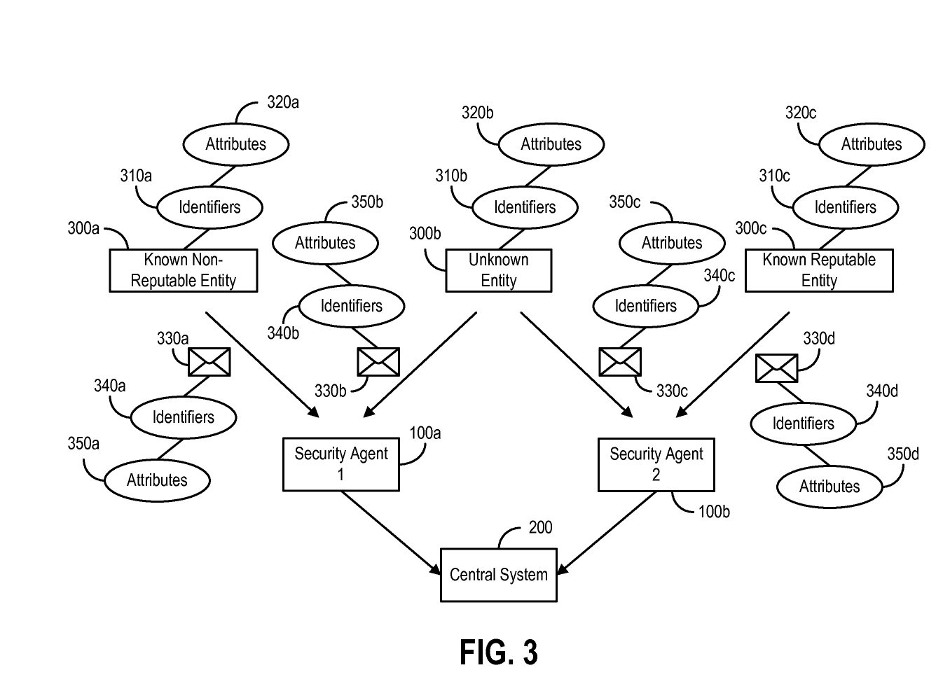

FIG. 3 is a block diagram depicting an example of communications and entities including using identifiers and attributes used to detect relationships between entities. Security agents 100a-b can collect data by examining communications that are directed to an associated network. Security agents 100a-b can also collect data by examining communications that are relayed by an associated network. Examination and analysis of communications can allow the security agents 100a-b to collect information about the entities 300a-c sending and receiving messages, including transmission patterns, volume, or whether the entity has a tendency to send certain kinds of message (e.g., legitimate messages, spam, virus, bulk mail, etc.), among many others.

As shown in FIG. 3, each of the entities 300a-c is associated with one or more identifiers 310a-c, respectively. The identifiers 310a-c can include, for example, IP addresses, universal resource locator (URL), phone number, IM username, message content, domain, or any other identifier that might describe an entity. Moreover, the identifiers 310a-c are associated with one or more attributes 320a-c. As should be understood, the attributes 320a-c correspond to the particular identifier 310a-c that is being described. For example, a message content identifier could include attributes such as, for example, malware, volume, type of content, behavior, etc. Similarly, attributes 320a-c associated with an identifier, such as IP address, could include one or more IP addresses associated with an entity 300a-c.

Furthermore, data from which the attributes can be determined can be collected from communications 330a-c (e.g., e-mail) that typically include some identifiers and attributes of the entity that originated the communication. For example, the communications 330a-c provide a transport for communicating information about the entity to the security agents 100a, 100b. The identifiers can be detected by the security agents 100a, 100b through examination of the header information included in the message, analysis of the content of the message, as well as through aggregation of information previously collected by the security agents 100a, 100b (e.g., totaling the volume of communications received from an entity).

The data from multiple security agents 100a, 100b can be aggregated and mined. For example, the data can be aggregated and mined by a central system 200 that receives identifiers and attributes associated with all entities 300a-c for which the security agents 100a, 100b have received communications. Alternatively, the security agents 100a, 100b can operate as a distributed system, communicating identifier and attribute information about entities 300a-c with each other. The process of mining the data can correlate the attributes of entities 300a-c with each other, thereby determining relationships between entities 300a-c (such as, for example, correlations between an event occurrence, volume, and/or other determining factors).

These relationships can then be used to establish a multi-dimensional reputation “vector” for all identifiers based on the correlation of attributes that have been associated with each identifier. For example, if a non-reputable entity 300a with a known reputation for being non-reputable sends a message 330a with a first set of attributes 350a, and then an unknown entity 300b sends a message 330b with a second set of attributes 350b, the security agent 100a can determine whether all or a portion of the first set of attributes 350a matched all or a portion of the second set of attributes 350b. When some portion of the first set of attributes 350a matches some portion of the second set of attributes 350b, a relationship can be created depending upon the particular identifier 320a, 320b that included the matching attributes 330a, 330b. The particular identifiers 340a, 340b that are found to have matching attributes can be used to determine a strength associated with the relationship between the entities 300a, 300b. The strength of the association can be used to determine how much of the non-reputable qualities of the non-reputable entity 300a are attributed to the reputation of the unknown entity 300b.

However, it should also be recognized that the unknown entity 300b may originate a communication 330c which includes attributes 350c that match some attributes 350d of a communication 330d originating from a known reputable entity 300c. The particular identifiers 340c, 340d that are found to have matching attributes can be used to determine a strength associated with the relationship between the entities 300b, 300c. The strength of the relationship can help to determine how much of the reputable qualities of reputable entity 300c are attributed to the reputation of the unknown entity 300b.

A distributed reputation engine also allows for real-time collaborative sharing of global intelligence about the latest threat landscape, providing instant protection benefits to the local analysis that can be performed by a filtering or risk analysis system, as well as identify malicious sources of potential new threats before they even occur. Using sensors positioned at many different geographical locations information about new threats can be quickly and shared with the central system 200, or with the distributed security agents 100a, 100b. Such distributed sensors can include the local security agents 100a, 100b, as well as local reputation clients, traffic monitors, or any other device suitable for collecting communication data (e.g., switches, routers, servers, etc.).

For example, security agents 100a, 100b can communicate with a central system 200 to provide sharing of threat and reputation information. Alternatively, the security agents 100a, 100b can communicate threat and reputation information between each other to provide up to date and accurate threat information. In the example of FIG. 3, the first security agent 100a has information about the relationship between the unknown entity 300b and the non-reputable entity 300a, while the second security agent 100b has information about the relationship between the unknown entity 300b and the reputable entity 300c. Without sharing the information, the first security agent 100a may take a particular action on the communication based upon the detected relationship. However, with the knowledge of the relationship between the unknown entity 300b and the reputable entity 300c, the first security agent 100a might take a different action with a received communication from the unknown entity 300b. Sharing of the relationship information between security agents thus provides for a more complete set of relationship information upon which a determination will be made.

The system assigns reputations (reflecting a general disposition and/or categorization) to physical entities, such as individuals or automated systems performing transactions. In the virtual world, entities are represented by identifiers (e.g., Internet protocol addresses, URLs, top-level domain names, phone numbers, etc.) that are tied to those entities in the specific transactions (such as sending a message or transferring money out of a bank account) that the entities are performing. Reputation can thus be assigned to those identifiers based on their overall behavioral and historical patterns as well as their relationship to other identifiers, such as the relationship of IP addresses sending messages or placing calls and URLs included in the messages or speech contained in the calls. A “bad” reputation for a single identifier can cause the reputation of other neighboring identifiers to worsen, if there is a strong correlation between the identifiers. For example, an IP address that is sending URLs that have a bad reputation will worsen its own reputation because of the reputation of the URLs. Finally, the individual identifier reputations can be aggregated into a single reputation (risk score or reputation score) for the entity that is associated with those identifiers

In various implementations, attributes can fall into a number of categories. For example, evidentiary attributes can represent physical, digital, or digitized physical data about an entity. This data can be attributed to a single known or unknown entity, or shared between multiple entities (forming entity relationships). Examples of evidentiary attributes relevant to messaging security include IP (internet protocol) address, known domain names, URLs, digital fingerprints or signatures used by the entity, TCP signatures, etc.

In additional implementations, behavioral attributes can represent human or machine-assigned observations about either an entity or an evidentiary attribute. Such attributes may include one, many, or all attributes from one or more behavioral profiles. For example, a behavioral attribute generically associated with a spammer or spitter (e.g., an entity that spams via VoIP) may by a high volume of communications being sent from that entity.

A number of behavioral attributes for a particular type of behavior can be combined to derive a behavioral profile. A behavioral profile can contain a set of predefined behavioral attributes. The attributed properties assigned to these profiles include behavioral events relevant to defining the disposition of an entity matching the profile. Examples of behavioral profiles relevant to messaging security might include “Spammer” or “Spitter”, “Spammer”, and “Legitimate Sender”. Events and/or evidentiary attributes relevant to each profile define appropriate entities to which a profile should be assigned. This may include a specific set of sending patterns, blacklist events, or specific attributes of the evidentiary data. Some examples include: Sender/Receiver Identification; Time Interval and sending patterns; Severity and disposition of payload; Message construction; Message quality; Protocols and related signatures; Communications medium; Message content; or Signal signatures.

In various implementations, entities sharing some or all of the same evidentiary attributes can have an evidentiary relationship. Similarly, entities sharing behavioral attributes have a behavioral relationship. These relationships help form logical groups of related profiles, which can then be applied adaptively to enhance the profile or identify entities slightly more or less standard with the profiles assigned.

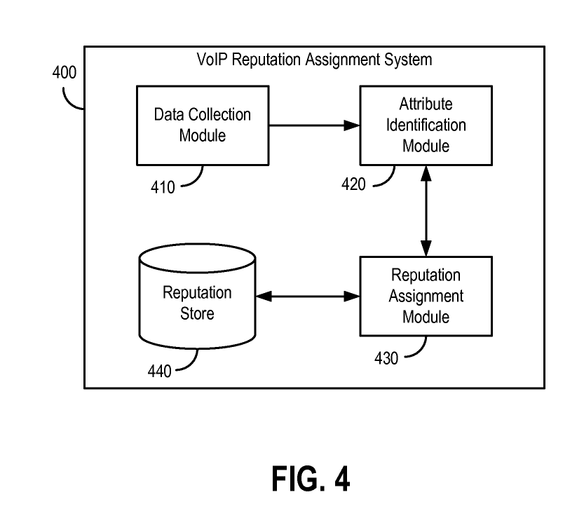

FIG. 4 is a block diagram illustrating an example voice over Internet protocol reputation system 400 that is operable to assign a VoIP reputation score to calls and entities.

The data collection module 410 is operable to collect VoIP call data. The data can include identifiers and attributes, for example, the IP address and/or telephone number of the sending entity and receiving entity, routing and signaling information, and the content of the call. The data can be collected by the data collection module when the Voip reputation system 400 is an active participant in a VoIP call or by passively collecting data about VoIP calls in a network. Data collection can be performed, for example, by a security agent 100, a client device, a switch, a router, or any other device operable to receive communications from network entities (e.g. web servers, IM servers, ISPs, file transfer protocol (FTP) servers, gopher servers, VoIP equipments, etc.).

The attribute identification module 420 is operable to identify attributes and associated identifiers in the collected VoIP call data. The attribute identification module 420 can identify address based identifiers such as IP addresses, phone numbers, and routing information. Additionally, the attribute identification module 420 can identify content based attributes such as voice identification, speech recognition, or voice fingerprints. Attribute identification module 420 can be implemented in a security agent 100 or alternatively a central system 200 operable to aggregate data from a number of sensor devices, including, for example, one or more security agents 100.

Reputation assignment module 430 is operable to identify relationships between the VoIP calls based on their identifiers and attributes. The reputation assignment module 430 can identity a relationship between calls and/or entities that have all or a portion of the same attributes. For example, if a non-reputable entity 300a with a known non-reputable reputation initiates a VoIP call with a first set of attributes 350a, and an unknown entity 300b initiates a VoIP call with a second set of attributes 350b, the reputation assignment module 430 can determine the relationship between the attributes 350a, 350b and the entities 300a, 300b.

The reputation assignment module 430 can assign a reputation score to the unknown entity 200b based on the relationships identified. The reputation assignment module 430 can consider the number of matching attributes between the entities as well as the particular matching attributes to assign the reputation score to the unknown entity 200b. For example, some attributes might strongly indicate a non-reputable entity, while other attributes might be less indicative of a non-reputable entity. Therefore, a single strong indicator of a non-reputable entity alone might represent a strong enough relationship to assign a reputation score identifying the unknown entity 200b as a non-reputable entity. Conversely, several matching attributes that are not as indicative of a non-reputable entity may not be representative of a strong enough relationship to assign a non-reputable reputation score to the unknown entity 200b. The reputation assignment module 430 can be implemented, for example, in a central system 200 or one or more distributed security agents 100.

The reputation store 440 is operable to store the reputation scores assigned by reputation assignment module 430. The reputation assignment module 430 can access the reputation scores stored in the reputation store 440 to match attributes of an unknown entity to attributes of previously detected entities. The reputation store 440 can be, for example, a local hard drive, shared network drive, tape storage, optical storage, or any other information storage device.

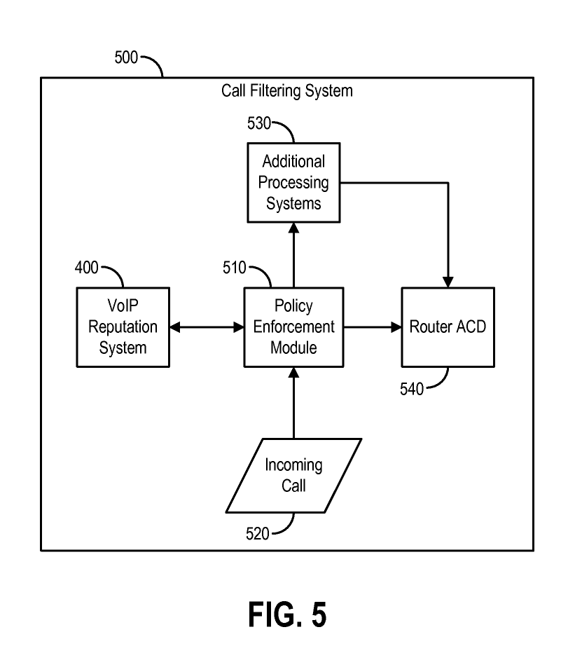

FIG. 5 is a block diagram illustrating an example call filtering system 500 using a Voip reputation system 400. The policy enforcement module 510 is operable to receive an incoming VoIP call 520 and to identify attributes and identifiers associated with the VoIP call 520. The policy enforcement module 510 can identify the identifiers and attributes in a similar manner as the attribute identification module 420 of the Voip reputation system 400, or can be cause the Voip reputation system 400 to identify the identifier and attributes.

The policy enforcement module 510 can query the reputation store to determine if a reputation score exists for the entity that initiated the VoIP call 520. If a reputation score exists for the entity, then the policy enforcement module 510 can apply the enforcement policy corresponding to the reputation score assigned to the entity. If a reputation score does not exist for the entity, the policy enforcement module 510 can search the reputation store to identify a relationship between the unknown entity and an entity having a reputation score stored in the reputation store. In some implementations, the policy enforcement module 510 can cause the reputation assignment module 430 to determine the relationship(s).

Once a reputation score has been determined for the unknown entity, the policy enforcement module 510 can enforce the policy corresponding to the reputation score. A policy can be enforced based on a reputation score alone, a reputation score and a particular identified attribute, or by a particular attribute alone. For example, if the unknown entity is identified as a non-reputable entity, the policy enforcement module 510 can enforce a policy of dropping the connection, thereby denying the unknown entity access to the destination VoIP phone or the network. In contrast, if the reputation score indicates that the unknown entity is a reputable caller, then the policy enforcement module 510 can enforce a policy that allows the call to be routed to the destination by the Router ACD 540.

If the entity reputation is non-determinative (e.g., identified neither as a reputable nor non-reputable caller), the policy enforcement module 510 can enforce a policy that block the unknown entity for a period of time or forward the call to another destination. Blocking the unknown entity for a period of time may be appropriate when the attributes of the call or the entity suggest that the unknown entity may be a non-reputable entity, but more data is needed to determine a reputation score (e.g., there is not a statistically relevant amount of data available for the particular attribute). By blocking the unknown caller for a period of time, additional data can be compiled to determine the reputation of the unknown caller.

Similarly, if the reputation score for the unknown entity is non-determinative the policy enforcement module 510 can enforce a policy to forward the call to another destination. For example, the call may be routed to a receptionist for verification that the call is being placed for legitimate purposes. Alternatively, the call can be forwarded to an additional processing module 530, such as a call challenge module. A call challenge module can, for example, require the unknown entity to answer a series of questions before the call is connected to the destination. Challenge questions can be a series of simple math questions requiring the unknown entity to speak the answer or enter it with their touchpad.

Additionally, the call challenge module can require the unknown entity to speak a particular phrase prior to connecting the unknown entity to the destination. The spoken phrase can be analyzed via voice recognition and speech recognition techniques. Voice recognition techniques identify the unique audible characteristics in the speech signal that can be compared to stored voice samples while speech recognition converts the spoken words into the actual words that are being spoken. Utilizing voice recognition, if the unique audible characteristics in the detected speech match a stored voice sample, then the unknown entity will be assigned the reputation score of the entity associated with the stored voice sample, and the corresponding policy can be enforced.

If voice recognition analysis does not yield a match or is not utilized, speech recognition can be utilized to analyze the actual words spoken by the unknown entity. For example, if the unknown entity is not identified via voice recognition it could either be that the unknown entity does not have a voice sample stored in the system, or that the unknown entity did not speak the correct phrase. Utilizing speech recognition, the call challenge module can verify that the words spoken by the unknown entity match the phrase that the unknown entity was asked to speak. If an alternative message is detected, this message can then be compared to other messages that have been detected by the system. If there is match, as might be the case if the content of the call is a recorded message sent to multiple destinations, then the unknown entity can be assigned the reputation score of the entity associated with the stored message, and the corresponding policy can be enforced. If there is no match after voice recognition analysis, speech recognition analysis, or both, further processing can take place or the call, according to the policies, e.g., disconnecting the call, routing to a mail box, routing to a receptionist, etc.

The additional processing module 530 can be implemented, for example, in the policy enforcement module a central system 200 or one or more distributed security agents 100. The policy enforcement module similarly can be implemented, for example, in a central system 200 or one or more distributed security agents 100.

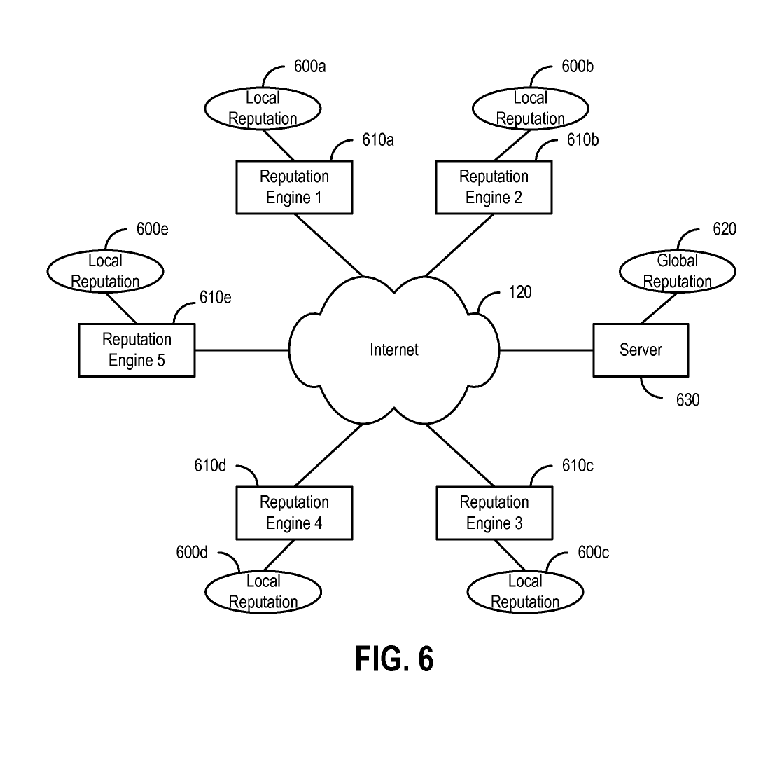

FIG. 6 is a block diagram illustrating an example network architecture including local reputations 600a-e derived by local reputation engines 610a-e and a global reputation 620 stored by one or more servers 630. The local reputation engines 610a-e, for example, can be associated with local security agents such as security agents 100. Alternatively, the local reputation engines 610a-e can be associated, for example, with a local client. Each of the reputation engines 610a-e includes a list of one or more entities for which the reputation engine 610a-e stores a derived reputation 600a-e.

These stored reputations can be inconsistent between reputation engines, because each of the reputation engines may observe different types of traffic. For example, reputation engine 1 610a may include a reputation that indicates a particular entity is reputable, while reputation engine 2 610b may include a reputation that indicates that the same entity is non-reputable. These local reputation inconsistencies can be based upon different VoIP call traffic received from the entity. Alternatively, the inconsistencies can be based upon the feedback from a user of local reputation engine 1 610a indicating a communication is legitimate, while a user of local reputation engine 2 610b provides feedback indicating that the same communication is not legitimate.

The server 630 receives reputation information from the local reputation engines 610a-e. However, as noted above, some of the local reputation information may be inconsistent with other local reputation information. The server 630 can arbitrate between the local reputations 600a-e to determine a global reputation 620 based upon the local reputation information 600a-e. In some examples, the global reputation information 620 can then be provided back to the local reputation engines 610a-e to provide these local engines 610a-e with up-to-date reputation information. Alternatively, the local reputation engines 610a-e can be operable to query the server 630 for reputation information. In some examples, the server 630 responds to the query with global reputation information 620.

In some implementations, the server 630 applies a local reputation bias to the global reputation 620. The local reputation bias can be applied to perform a transform on the global reputation to provide the local reputation engines 610a-e with a global reputation vector that is biased based upon the preferences of the particular local reputation engine 610a-e which originated the query. Thus, a local reputation engine 610a with an administrator or user(s) that has indicated a high tolerance for VoIP spam can receive a global reputation vector that accounts for an indicated tolerance. The particular components of the reputation vector returned to the reputation engine 610a can include portions of the reputation vector that are deemphasized with relationship to the rest of the reputation vector. Likewise, a local reputation engine 610b that has indicated, for example, a low tolerance communications from entities with reputations for originating viruses may receive a reputation vector that amplifies the components of the reputation vector that relate to virus reputation.

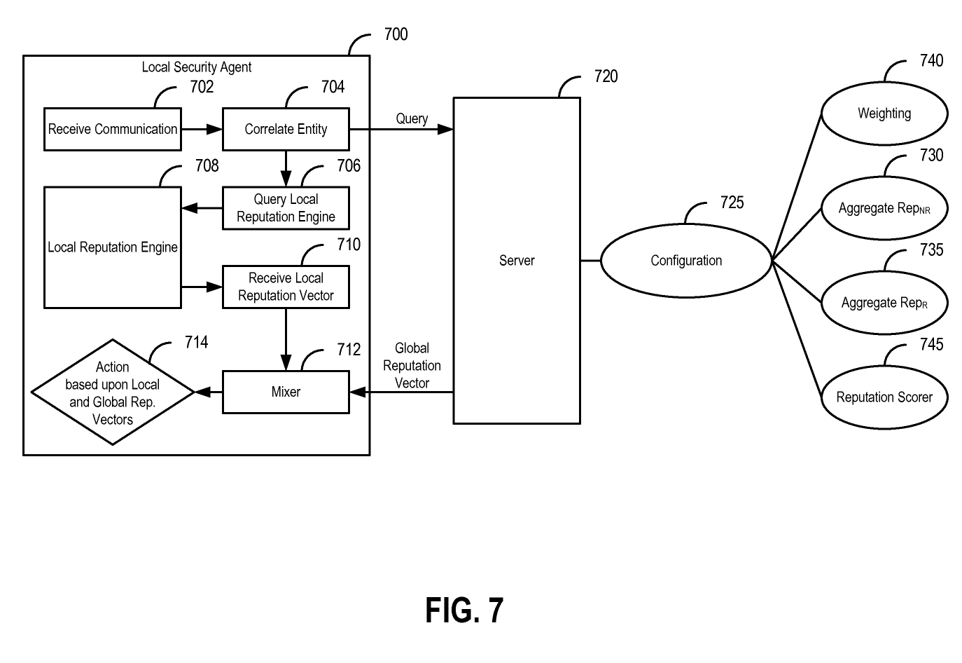

FIG. 7 is a block diagram illustrating an example resolution between a global reputation and a local reputation. The local security agent 700 communicates with a server 720 to retrieve global reputation information from the server 720. The local security agent 700 can receive a communication at 702. The local security agent can correlate the communication to identify attributes of the VoIP call at 704. The attributes of the call can include, for example, an originating entity, a fingerprint of the voice content, a destination entity, etc. The local security agent 700 includes this information in a query to the server 720. In other examples, the local security agent 700 can forward the call to the server 720, and the server can perform the correlation and analysis of the message.

The server 720 uses the information received from the query to determine a global reputation based upon a configuration 725 of the server 720. The configuration 725 can include a plurality of reputation information, including both information indicating that a queried entity is non-reputable 730 and information indicating that a queried entity is reputable 735. The configuration 725 can also apply a weighting 740 to each of the aggregated reputations 730, 735. A reputation scorer 745 can provide the engine for weighting 740 the aggregated reputation information 730, 735 and producing a global reputation vector.

The local security agent 700 then sends a query to a local reputation engine at 706. The local reputation engine 708 performs a determination of the local reputation and returns a local reputation vector at 710. The local security agent 700 also receives a response to the reputation query sent to the server 720 in the form of a global reputation vector. The local security agent 700 then mixes the local and global reputation vectors together at 712. In some implementations, the mixing includes addition of vector components; in other implementations, the mixing includes setting a vector component equal to one of two values that have a highest absolute magnitude. An action is then taken with respect to the received message at 714, e.g., the application of one or more policies, as described above.

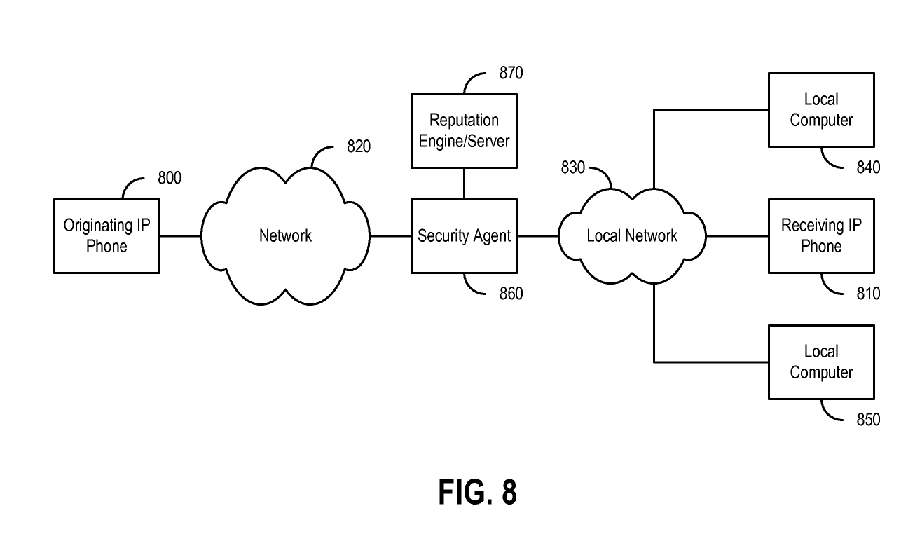

FIG. 8 is a block diagram illustrating reputation based connection throttling for voice over Internet protocol (VoIP) or short message service (SMS) communications. An originating IP phone 800 can place a VoIP call to a receiving IP phone 810. These IP phones 800, 810 can be, for example, computers executing soft-phone software, network enabled phones, etc. The originating IP phone 800 can place a VoIP call through a network 820 (e.g., the Internet). The receiving IP phone 810 can receive the VoIP call through a local network 830 (e.g., an enterprise network).

Upon establishing a VoIP call, the originating IP phone has established a connection to the local network 830. This connection can be exploited similarly to the way e-mail, web, instant messaging, or other Internet applications can be exploited for providing unregulated connect to a network. Such exploitation places computers 840, 850 operating on the local network 830 at risk for intrusion, viruses, Trojan horses, worms, and various other types of attacks based upon the established connection. Moreover, because of the time sensitive nature of VoIP communications, these communications are typically not examined to ensure that the connection is not being misused. For example, voice conversations occur in real-time. If a few packets of a voice conversation are delayed, the conversation becomes stilted and difficult to understand. Thus, the contents of the packets typically cannot be examined once a connection is established.

However, a local security agent 860 can use reputation information received from a reputation engine or server 870 to determine a reputation associated with the originating IP phone. The local security agent 860 can use the reputation of the originating entity to determine whether to allow a connection to the originating entity. Thus, the security agent 860 can prevent connections to non-reputable entities, as indicated by reputations that do not comply with the policy of the local security agent 860.

In some examples, the local security agent 860 can throttle the connection to control the flow rate of packets being transmitted using the connection established between the originating IP phone 800 and the receiving IP phone 810. Thus, originating entities 800 with a non-reputable reputation can be allowed to make a connection to the receiving IP phone 810. However, the packet throughput will be capped, thereby preventing the originating entity 800 from exploiting the connection to attack the local network 830. Alternatively, the throttling of the connection can be accomplished by performing a detailed inspection of any packets originating from non-reputable entities. As discussed above, the detailed inspection of all VoIP packets is not efficient. Thus, quality of service (QoS) can be maximized for connections associated with reputable entities, while reducing the QoS associated with connections to non-reputable entities. Standard communication interrogation techniques can be performed on connections associated with non-reputable entities in order to discover whether any of the transmitted packets received from the originating entity comprise a threat to the network 830. Various interrogation techniques and systems are described in U.S. Pat. No. 6,941,467, No. 7,089,590, No. 7,096,498, and No. 7,124,438 and in U.S. Patent Application Nos. 2006/0015942, 2006/0015563, 2003/0172302, 2003/0172294, 2003/0172291, and 2003/0172166, which are hereby incorporated by reference.

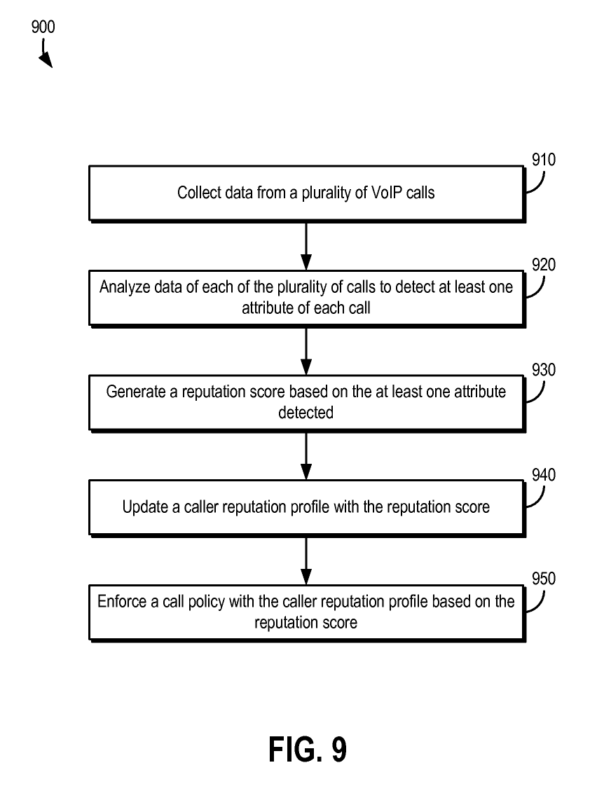

FIG. 9 is a flowchart illustrating an example method of detecting relationships and assigning reputations to entities associated with VoIP calls. The operational scenario begins at step 910, which collects data from a plurality of VoIP calls. Data collection can be completed actively, as a participant in the VoIP call or call path, or it can be completed passively by detecting VoIP traffic on a network. The data collection can be completed, for example, by a security agent 100, a client device, a switch, a router, or any other device operable to receive communications from network entities (e.g., e-mail servers, web servers, IM servers, ISPs, file transfer protocol (FTP) servers, gopher servers, VoIP equipments, etc.).

Step 920 analyzes the data of each of the plurality of calls to detect at least one attribute of each call. The at least one attribute can be address based identifiers or content based attributes associated with the collected data. Address identifiers can vary according to the type of communication received. For example, if the VoIP call originates from an IP phone, then the address based identifiers will not include a telephone number. However, if the VoIP call originates from a PSTN telephone then the address based identifiers can include a telephone number. Content based attributes can include, for example, voice signal, a message content, etc.

Step 920 can also analyze the data of the plurality of calls to classify the calls (e.g., distinct caller IDs, number of calls from one ID, etc), recognizing call patterns (e.g., calls from a common IP address every 2 second, sequential number dialing, etc), or challenging the caller (e.g., answering questions, speaking a phrase, etc) to perform voice or speech recognition. Step 920 can be performed, for example, by the attribute identification module 420, security agent 100 or by a central system 200 operable to aggregate data from a number of sensor devices, including, for example, one or more security agents 100.

Step 930 generates a reputation score based on the at least one attributes detected. The reputation score can be determined based on the results of the call analysis. The determination can include comparing attributes related to different entities to find relationships between the entities and assigning a reputation score based on the relationships. For example, the VoIP caller can be assigned a reputation score associated with a non-reputable caller if the attributes detected and analyzed are known to be related with non-reputable callers. Step 930 can be performed, for example, by the reputation assignment module 430, central system 200 or one or more distributed security agents 100. Moreover, based upon the particular attribute, which serves as the basis for the relationship, a strength can be associated with the relationship.

Step 940 updates a caller reputation profile with the reputation score. The reputation score can be associated with the caller and the corresponding caller attributes. The reputation score can change over time, as more data regarding the caller and the corresponding caller attributes is collected and analyzed. The reputation score can be assigned by the reputation assignment module 430, central system 200 or by one or more security agents 100.

Step 950 associates a call policy with the caller reputation profile based on the reputation score. The call policy can define actions to be taken when a call is received from the caller. For example, the policy can allow the call to proceed to its destination, drop the call, block the caller for a period of time, or forward the call to another destination. The call policy can be enforced by use of the reputation profile, for example, by the reputation assignment module 430, central system 200 or one or more distributed security agents 100. The call policy and caller reputation profile can be stored in the reputation store 440 or any other storage device.

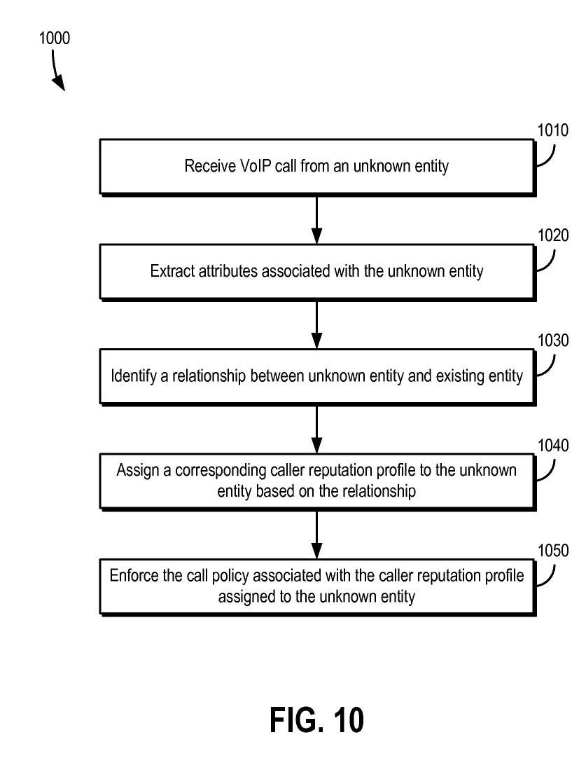

FIG. 10 is a flow chart illustrating an example method of filtering incoming VoIP calls. The operational scenario beings at step 1010, which receives a VoIP call from an unknown entity. The call can originate from a PSTN phone or an IP phone. The call can be received by a security agent 100, a client device, a switch, a router, or any other device operable to receive communications from network entities (e.g., e-mail servers, web servers, IM servers, ISPs, file transfer protocol (FTP) servers, gopher servers, VoIP equipments, etc.).

Step 1020 identifies attributes associated with the unknown entity. The attributes can include address based identifiers (e.g., IP address, phone number, etc) and/or content based attributes (e.g., voice signal, message content, etc). The attributes can be extracted, for example, by the policy enforcement module 510.

Step 1030 identifies a relationship between the unknown entity and an existing entity. The existing entity is any entity that has a reputation profile stored in the reputation store 440. The relationship can be based on the number of matching attributes between the entities or the strength of the matching attributes as indicators of caller reputation. For example, a single matching attribute may be highly predictive of caller reputation, while numerous matching attributes can be less predictive of caller reputation. The relationship can be identified, for example, by the policy enforcement module 510.

Step 1040 assigns a corresponding caller reputation profile to the unknown entity based on the relationship to the existing entity. The reputation profile can define a call policy to be enforced for the unknown caller. The reputation profile can be assigned, for example, by the policy enforcement module 510.

Step 1050 enforces a corresponding call policy based on the caller reputation profile assigned to the unknown entity. The call policy can define actions to be taken when a call is received from the caller. For example, the policy can allow the call to proceed to its destination, drop the call, block the caller for a period of time, or forward the call to another destination. The call policy can be enforced, for example, by the policy enforcement module 510.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be computer readable medium, such as a machine-readable storage device, a machine-readable storage substrate, a memory device, or a combination of one or more of them.

The terms “computer” or “server” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or one that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for filtering a VoIP calls based upon caller reputation, comprising:
collecting data from a plurality of VoIP calls;
analyzing the data for each of the plurality of calls to detect at least one attribute of each call;
generating a reputation score for a first entity based on the at least one attribute detected;
updating a caller reputation profile for the first entity with the reputation score for the first entity; and
associating a call policy with the caller reputation profile based on the reputation score.

2. The method of claim 1, further comprising:
receiving a VoIP call from an unknown entity;
determining attributes associated with the unknown entity;
identifying a relationship between the unknown entity and the first entity entity, the existing entity being an entity having a reputation profile stored in the reputation store;
assigning a corresponding caller reputation profile to the unknown entity based on the relationship to the existing entity; and
enforcing a corresponding call policy on the VoIP call from the unknown entity based on the caller reputation profile assigned to the unknown entity, the call policy associated with the caller reputation profile assigned to the unknown entity.

3. The method of claim 1, wherein the VoIP call originates from a PSTN network.

4. The method of claim 1, wherein the attribute is an address based attribute.

5. The method of claim 4, wherein the address based attribute comprises an IP address.

6. The method of claim 5, wherein the address based attribute further comprises a telephone number.

7. The method of claim 1, wherein the attribute is a content based attribute.

8. The method of claim 7, wherein the content based attribute comprises a call content attribute.

9. The method of claim 8, wherein the call content attribute comprises a voice signal.

10. The method of claim 2, wherein enforcing a corresponding call policy on the VoIP call from the unknown entity based on the caller reputation profile assigned to the unknown entity comprises throttling the VOIP call to control a flow rate of packets being transmitted over the VOIP call.

11. A method for filtering a VoIP call based upon caller reputation, comprising:
collecting data from a plurality of VoIP calls;
determining at least one attribute for each of the plurality of calls from the data collected for each call;
identifying relationships between the VoIP calls based on the determined attributes;
assigning a reputation score to a first entity based on the identified relationships; and
associating a call policy with a caller reputation profile based on the reputation score.

12. The method of claim 11, further comprising:
receiving a VoIP call from an unknown entity;
determining attributes associated with the unknown entity;
identifying a relationship between the unknown entity and the first entity based on the determined attributes;
assigning a corresponding reputation score to the unknown entity based on the relationship to the first entity, the corresponding reputation score based in part on the reputation score assigned to the first entity; and
enforcing a corresponding call policy on the VoIP call based on the corresponding reputation score assigned to the unknown entity.

13. The method of claim 12, wherein enforcing a corresponding call policy on the VoIP call based on the corresponding reputation score assigned to the unknown entity comprises throttling the VOIP call to control a flow rate of packets being transmitted over the VOIP call.

14. The method of claim 12, wherein the VoIP call originates from a PSTN network.

15. The method of claim 12, wherein the attribute is an address based attribute.

16. The method of claim 15, wherein the address based attribute comprises an IP address.

17. The method of claim 12, wherein the attribute is a content based attribute comprising a voice signal.

18. A system for filtering VoIP calls based upon caller reputation, comprising:
a data collection module operable to collect data associated with a plurality of calls;
an attribute identification module in communication with the data collection module and operable to identify attributes from the plurality of calls;
a reputation assignment module in communication with the attribute identification module and operable to identify relationships between the calls based on the attributes and assign a reputation score to an entity based on the relationships; and
a policy enforcement module in communication with the reputation assignment module and operable to enforce policies based on the reputation score.
